(19) United States
(12) Patent Application Publication
(10) Pub. No.: US 2010/0190628 A1
(43) Pub. Date: Jul. 29, 2010

(54) METHOD AND APPARATUS FOR THE PRODUCTION OF A FOLDED SHEET

(76) Inventors: Dieter Gansert, Kindenheim (DE); Markus Kneip, Koblenz (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/665,590

(22) PCT Filed: Jun. 17, 2008
(86) PCT No.: PCT/DE2008/000985

§ 371 Date: Dec. 18, 2009

(30) Foreign Application Priority Data
Jun. 18, 2007 (DE) 10 2007 027 945.2

(51) Int. Cl. B31F 1/00

(52) U.S. Cl. 493/416

(57) ABSTRACT

Disclosed are a method and an apparatus for producing a folded sheet, the sheet being fed using a feeding mechanism, being aligned using an aligning device, and being folded using a folding device. The aim of the invention is to simplify production, render the production process more flexible, and reduce costs. Furthermore, an alternative apparatus should allow the production costs to be reduced by improving the quality. In the disclosed method, said aim is achieved by positioning the sheet at an angle from the direction of travel during the feeding process, aligning the sheet that has been positioned at an angle, and transferring the aligned sheet into a folding device to produce at least one fold that extends at an angle to the edges of the sheet. In a first embodiment, said aim is also achieved by an apparatus in which the folding device is a buckle folding unit, the shape of the first buckle of which is adapted to the edges of the sheet that are positioned at an angle. In a second embodiment, said aim is further achieved by an apparatus in which the aligning device has at least one stop which can be rotated about an axis of rotation in the direction of travel of the aligned sheet in order to allow the sheet to be conveyed.

The present invention pertains to a method for producing a folded sheet, in which the sheet is fed, aligned and folded. In addition, an apparatus for producing a folded sheet, particularly for carrying out the method, with a feeding mechanism, an aligning device and at least one folding device is disclosed.

Numerous folding methods and folding apparatuses are known from practical applications, wherein the folding edges extend parallel to the edges of a sheet of paper or cardboard. However, there certainly is also a demand for paper products with a folding edge or several folding edges that extend obliquely referred to the edge of a sheet. Such a demand exists, e.g., in the advertising industry that wants to attract attention with unusual paper foldings. In addition to the aesthetic purpose of a certain folding, preferably a multiple diagonal folding, it also has an entirely practical purpose, namely that of tightly folding the sheet in such a way that no automatic unfolding occurs after the folding process. A high demand for brochures with a small volume primarily exists in the pharmaceutical industry because folded slips of paper in the packaging of medications are difficult to handle, particularly when they need to be returned into the packaging.

An apparatus for producing folded sheets with a folding edge that extends obliquely referred to the sheet edge is described in DE 10 2004 027 199 A1. Basic process steps can also be derived from this disclosure and comprise the following basic steps:

feeding the sheet from a feeder unit to an automatic knife folding device,

aligning the sheet obliquely referred to the knife of the automated knife folding device with the aid of orientation means in the automated knife folding device,

folding.

In this method, only a single fold can be produced and the desired originality of an end product that preferably is obliquely folded several times is very limited. This is the reason why the following steps can also be carried out:

transferring the folded sheet from the automated knife folding device to a turning station, in which the sheet is turned,

aligning the turned and folded sheet parallel to the edges of the sheet in the turning station, transferring the sheet into an automated buckle folding device,

folding the sheet once again.

In an automated buckle folding device, several folds can be produced because several buckles are provided. However, the sheet needs to be turned and aligned once again in this case because the inner stopping edge of a conventional buckle folding device is only adapted to the edge of a sheet that lies straight.

The known apparatus basically comprises a feeding mechanism, an aligning device and an automatic folding device and already makes it possible to produce a fold obliquely referred to an edge of a rectangular sheet.

In the known method, a product that is folded several times requires a plurality of process steps, particularly two aligning steps and at least two different folding devices, and therefore is relatively costly. It is also disadvantageous that the oblique positioning is imperatively tied to the automated knife folding device and therefore does not provide any alternatives with respect to the folding device.

The invention is based on the objective of disclosing a method and an apparatus of the initially cited type that simplify the production, are realized more flexibly and lower the costs. According to an alternative apparatus, the production costs should be lowered by improving the quality.

With respect to the method, the aforementioned objective is attained with the characteristics of Claim 1. According to this claim, a method of the described type is realized in such a way that the sheet is transferred into an oblique position referred to the moving direction during the feeding process, that the obliquely positioned sheet is aligned, and that the aligned sheet is transferred into a folding device in order to produce at least one fold that extends at an angle referred to the edges of the sheet.

With respect to the apparatus, the aforementioned objective is attained with the characteristics of the two alternative Claims 13 and 19.

According to Claim 13, the first alternative of an apparatus of the described type is realized in such a way that the folding device consists of a buckle folding mechanism, wherein the shape of the first buckle of the buckle folding mechanism is adapted to the obliquely positioned edges of the sheet.

According to Claim 19, the second alternative of an apparatus of the described type is realized in such a way that the aligning device features stops that are rotatable about an axis of rotation in the moving direction of the aligned sheet.

Based on the state of the art according to DE 10 2004 027 199 A1, it was initially recognized that basically only one fold can be produced obliquely to the sheet edges in an automated knife folding device after a corresponding alignment, and that other folding steps can only be carried out in another folding device after subsequent turning and aligning steps. According to the invention, it was recognized that such a production method can be simplified, as well as realized in a less costly and more flexible fashion, if the feeding mechanism already makes it possible to obliquely position the sheet, if this sheet is aligned means of a separate aligning device, and if the sheet is then directly transferred into a folding device that makes it possible to produce more than one fold. In comparison with the pertinent state of the art, one folding device and one aligning process are eliminated. Another advantage can be seen in that it is possible to choose the type of folding device that follows the aligning device and to thusly increase the flexibility of the production.

With respect to the first alternative of the apparatus, it was recognized, according to the invention, that the inventive method can be carried out with a folding device in the form of a buckle folding mechanism, the first buckle of which is adapted to the obliquely positioned and aligned edges of the sheet. Conventional buckle folding mechanisms only realize an internal shaping parallel to the edges. The first alternative of the inventive device provides a first buckle that can accommodate the obliquely positioned edges of the aligned sheet.

With respect to the second alternative of the apparatus, it was recognized, according to the invention, that the production costs can be minimized by improving the quality if the separate aligning device according to the invention features special stops. The peculiarity of these stops concerns their novel mobility. Stops according to the state of the art known from practical applications are displaced downward perpendicular to the supporting surface of the sheet in order to release the path for the sheet to the next processing station. Damages to the sheet edges may occur during this process. The second alternative of the inventive apparatus is provided with stops that are rotatable about an axis of rotation in the moving direction of the aligned sheet. The stops are pivoted away without being in contact with the sheet edges. This advantageously precludes damages and the costs are lowered due to the avoidance of waste products.

In order to realize the oblique position of the sheet, it could be fed to an aligning device one two conveyor belts that operate with different speeds. The aligning device could be advantageously realized in the form of a separate structural unit that can be combined with different feeding mechanisms and/or folding devices.

The movement of the conveyor belts could be used for additionally moving the sheet during its introduction into the aligning device. According to one variation of the inventive method, the sheet could partially remain on the conveyor belts during its introduction into the aligning device and be subjected to a feed force by these conveyor belts. Alternatively or additionally, it would naturally also be possible to provide separate driven belts or rollers within the aligning device in order to move the sheet within the aligning device. In any case, it needs to be ensured that the sheet reaches stops of the aligning device, on which the edges of the sheet are aligned.

After the sheet has reached the stops and the aligning process is completed, a vacuum could be applied to the sheet in order to maintain the desired position and to fix the sheet in the alignment realized with the aid of the stops. A suction belts or a suction roller could be provided for generating the vacuum. In order to move the sheet to the folding device, the stops need to be removed from the transport path such that the path to the transfer to the folding device is released.

The transport to the folding device could be realized by means of a suction belt or a suction roller. In order to prevent jerking of a starting belt after the alignment and suction processes, the suction belt could already be in motion when the sheet arrives from the feeding mechanism. However, only very slow speeds of no more than 1 m/min can be considered in this case so as to not impair the suction process. The sheet could be folded at least once at an angle referred to the edges in the folding device.

If a plough folding mechanism is chosen in accordance with one variation of the method, it is either necessary to use a pre-scored sheet or the sheet needs to pass through a scoring station before it is introduced into the plough folding mechanism. In any case, the plough folding mechanism needs to be equipped with two parallel profiled sheets, as well as produce two folds in one pass and fold the sheet accordingly.

If a folding device in the form of buckle folding mechanism is chosen in accordance with another variation of the method, it is possible to carry out several folding processes in different buckles of the buckle folding mechanism. However, since the sheet is transferred into an oblique position in order to produce a fold that does not extend parallel to one of the sheet edges, the shape of the first buckle of the buckle folding mechanism needs to be adapted to the obliquely positioned edges of the sheet. A “diagonal” receptacle quasi needs to be provided within the buckle.

As mentioned above, additional folding processes may be subsequently carried out in other buckles of the same buckle folding mechanism. In this case, the buckles of the same buckle folding mechanism that follow the first buckle do not require a special design. A straight edge is then once again provided by the first fold.

If a sheet is initially square, the corner situated opposite of the first fold can also be folded without a special internal shape of the second buckle by simply moving the sheet into the second buckle by means of the first fold and increasing the intake length in order to produce the second fold parallel to the first fold. If it is subsequently desired to also fold the two remaining 90° corners of this square sheet, the sheet that is folded twice in this example may exit the buckle folding mechanism and be transferred into a second buckle folding mechanism, the first buckle of which features a “diagonal” receptacle. The second buckle folding mechanism could be arranged offset relative to the first buckle folding mechanism by 90° such that the sheet no longer needs to be turned. It goes without saying that the folded sheets are transported away after the folding process.

The buckle folding mechanism arranged downstream of the aligning device and/or another buckle folding mechanism could feature up to twelve buckles. This makes it possible to directly produce several folds within a folding device and to create complicated shapes that are particularly interesting for mailed advertisements.

Embodiments of the device were already discussed with respect to the connection of a transport section or the transfer from a first to a second buckle folding mechanism with a modified first buckle, as well as with respect to the positioning of the second buckle folding mechanism opposite of the first buckle folding mechanism, in connection with the description of the method.

A particularly high flexibility of the inventive apparatus could be achieved if the aligning device consists of a separate structural unit. In this case, a module is provided that can be combined with different feeding mechanisms and/or folding devices—depending on the respective requirements.

The aligning device could advantageously feature stops that are adapted to the obliquely positioned edges of the sheet. According to one preferred embodiment that is particularly advantageous with respect to the quality of the sheet edges, the stops could be rotatable about axes of rotation in the moving direction of the aligned sheet. The stops are simply pivoted away, however, without being in contact with the sheet edges. This advantageously precludes damages and the costs are lowered due to the avoidance of waste products. In this case, the axis of rotation of the stops extends transverse to the moving direction of the aligned sheet. The stop is pivoted downward if it is fixed underneath the supporting surface of the sheet. The stop is rotated upward in order to release the path to the folding device if it is fixed above the supporting surface of the sheet. A control could be advantageously provided in order to coordinate the movement of the stops at the correct time.

All components of the apparatus—with the exception of the separate aligning device—are based on standard work units. Even the first buckle of a buckle folding mechanism that is modified in accordance with the invention can be installed without excessive expenditures.

Different options are available for advantageously realizing and additionally developing the present invention. In this respect, we refer to the claims that are respectively dependent on Claims 1, 13 and 19, as well as to the following description of one exemplary embodiment of the invention with reference to the drawings. Generally preferred embodiments and additional developments of the invention are also discussed in connection with the description of the exemplary embodiment of the invention. In the drawings,

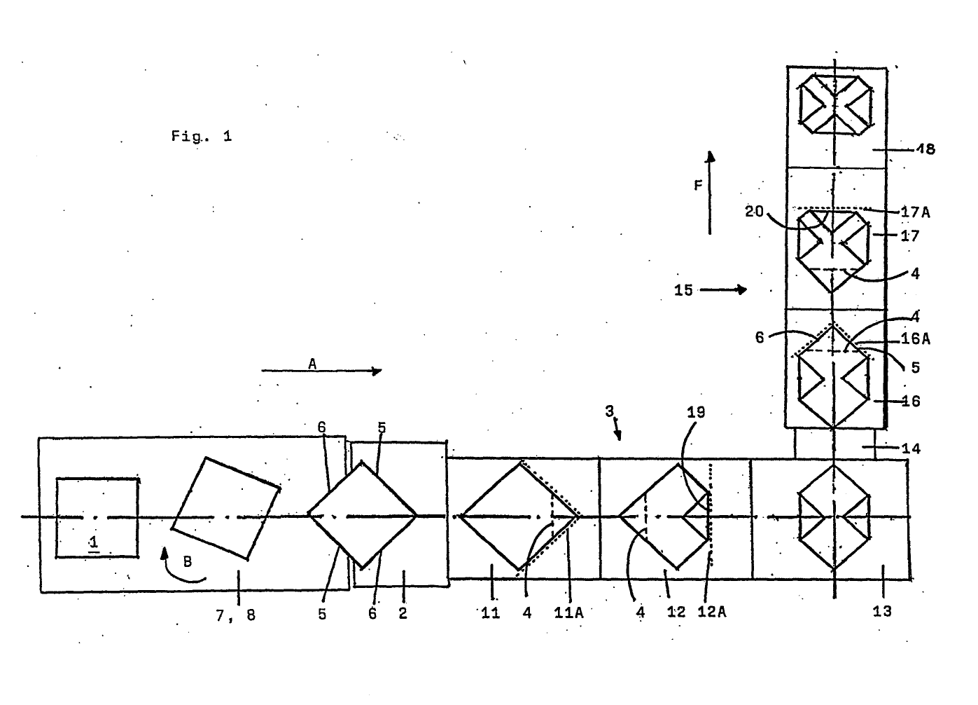

FIG. 1 shows a purely schematic, sketchy representation of the inventive apparatus and the inventive method;

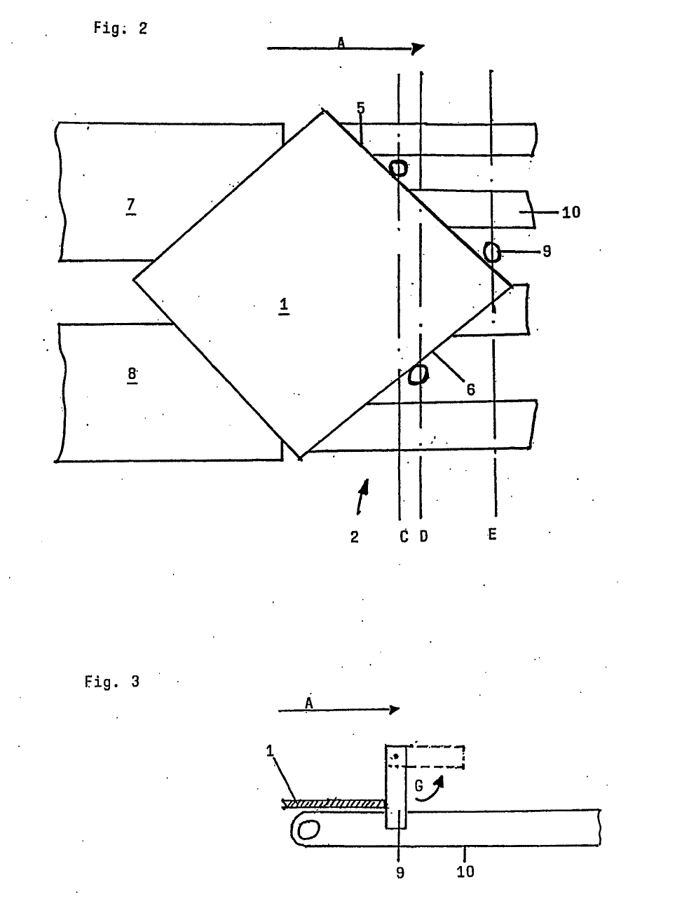

FIG. 2 shows an enlarged schematic representation of a detail of FIG. 1, namely a horizontal projection of a sheet that is partially situated on the conveyor belts and partially situated in the aligning device, and

FIG. 3 shows a schematic side view of a detail of FIG. 2 that concerns a chosen stop.

FIG. 1 schematically shows the steps of the method and the apparatus according to the invention. They are used for producing a sheet 1 that is folded four times in this exemplary embodiment, wherein this sheet is initially fed, aligned and ultimately folded.

According to the invention, the sheet 1 is transferred into an oblique position referred to the moving direction A while it is fed by means of conveyor belts 7, 8, wherein the sheet is turned by exactly 90° in the direction B in this case such that one corner of the square sheet 1 points in the direction of the aligning device 2. The conveyor belts 7, 8 illustrated in FIG. 2 operate with different speeds so as to realize the turning of the sheet in the direction B. In this case, the conveyor belt 7 moves faster than the conveyor belt 8. The obliquely positioned sheet 1 is now aligned in the aligning device 2 and subsequently transferred into a folding device 3 in order to produce a fold 4 that is always illustrated with broken lines and to fold the sheet along this fold 4 that extends at an angle referred to the edges 5, 6 of the sheet 1.

The aligning device 2 is realized in the form of a separate structural unit that can be combined with different feeding mechanisms and/or folding devices 3. FIG. 2 shows that the sheet 1 partially remains on the conveyor belts 7, 8 during its introduction into the aligning device 2 and that these conveyor belts subject the sheet to a feed force. The sheet 1 is fed up to the three stops 9 of the aligning device 2, on which the edges 5, 6 of the sheet 1 are aligned. After the alignment, a vacuum is applied to the sheet 1 such that it is fixed in the alignment realized with the aid of the stops 9. The vacuum is applied by four suction belts 10 that transfer the sheet 1 to the folding device 3 after the path has been released by the intermittently removable stops 9.

In the folding device 3, the sheet 1 is initially folded once at an angle referred to the edges 5, 6 along the fold 4. In the present exemplary embodiment, the folding device 3 consists of a buckle folding mechanism, wherein the shape 11A of the first buckle 11 of this buckle folding mechanism is indicated with a dotted line in FIG. 1 and adapted to the obliquely positioned edges 5, 6 of the sheet 1. The first buckle 11 quasi contains a “diagonal” receptacle. After the first folding or the production of the first fold 4, the sheet 1 is transferred into a second buckle 12 of the folding device 3. The internal shape 12A of this second buckle is conventionally realized linearly, wherein this is possible because the new edge 19 of the sheet 1 created by the first fold 4 forms the contact edge in this case. The sheet 1 is folded twice at this point and has a hexagonal shape, wherein the thusly folded sheet is transferred into an outlet region 13 of the folding device 3.

The sheet 1 is transferred from the outlet region 13 to a transport section 14 leading to an additional buckle folding mechanism 15. The shape 16A illustrated with dots or a quasi “diagonal” receptacle that is adapted to the obliquely positioned edges 5, 6 of the sheet 1 is provided in the first buckle 16 of the additional buckle folding mechanism 15.

After the third folding or the production of the third fold 4, the sheet 1 is transferred into a second buckle 17 of the folding device 15. The internal shape 17A of this second buckle is conventionally realized linearly. The new edge 20 of the sheet 1 created by the third fold 4 forms the contact edge in this case. The sheet 1 is now folded four times and has an octagonal shape, wherein the thusly folded sheet is transferred into an outlet region 18. Since the width of the sheet 1 is already reduced by folding the sheet twice, the structural width of the buckle folding mechanism 15 is smaller than that of the folding device 3.

The additional buckle folding mechanism 15 is arranged offset relative to the folding device 3 by 90° and the moving direction is indicated with the reference symbol F in this case. Due to this arrangement, it is no longer necessary to once again turn the sheet 1.

FIGS. 2 and 3 show how the stops 9 of the aligning device 2 release path to the folding device 3. The rotation takes place in the rotating direction G and in the moving direction A, namely about the axes of rotation C, D, E that extend transverse to the moving direction A of the aligned sheet 1.

The stops 9 are fixed above the suction belts 10 within the space between the suction belts and are rotatable upward in the rotating direction G. A controlled 90° rotation takes place in this case.

With respect to other characteristics that are not illustrated in the figures, we refer to the general portion of the description.

In conclusion, it should be noted that the invention is not limited to the above-described exemplary embodiment. Different folding devices, in particular, may be combined into various arrangements, the constructive implementation of the pivoted stops may be realized quite differently and the final shape of the folded sheet 1 may be configured in an infinitely variable fashion, e.g., stellate.

### LIST OF REFERENCE SYMBOLS

1 Sheet
2 Aligning device
3 Folding device
4 Fold
5 Edge
6 Edge
7 Conveyor belt
8 Conveyor belt
9 Stop
10 Suction belt
11 First buckle of 3
11A Shape
12 Second buckle of 3
12A Shape
13 Outlet region
14 Transport section
15 Buckle folding mechanism
16 First buckle of 15
16A Shape
17 Second buckle of 15
17A Shape
18 Outlet region
19 Edge
20 Edge
A Moving direction
B Rotating direction
C Axis of rotation
D Axis of rotation
E Axis of rotation
F Moving direction
G Rotating direction

1.-22. (canceled)

23. A method for producing a folded sheet, in which the sheet is fed, aligned and folded, wherein the sheet is transferred into an oblique position relative to the moving direction during the feeding process, wherein the obliquely positioned sheet is aligned, and wherein the aligned sheet is transferred into a folding device in order to produce at least one fold that extends at an angle relative to the edges of the sheet.

24. The method according to claim 23, wherein the sheet is fed to an aligning device on two conveyor belts that operate with different speeds.

25. The method according to claim 24, wherein the aligning device comprises a separate structural unit that can be combined with different feeding mechanisms or folding devices.

26. The method according to claim 24, wherein the sheet partially remains on the conveyor belts during its introduction into the aligning device and is subjected to a feed force by these conveyor belts.

27. The method according to claim 24, wherein the sheet is fed up to stops of the aligning device, on which the edges of the sheet are aligned.

28. The method according to claim 27, wherein a vacuum is applied to the sheet after its alignment such that the sheet is fixed in the alignment realized with the aid of the stops.

29. The method according to claim 28, wherein the stops are temporarily eliminated after the fixing process and release the path for transferring the sheet to the folding device.

30. The method according to claim 29, wherein the sheet is transferred to the folding device by means of at least one suction belt or a suction roller of the aligning device.

31. The method according to claim 23, wherein the sheet is at least folded once at an angle relative to the edges in the folding device.

32. The method according to claim 31, wherein the folding device comprises a plough folding mechanism with two parallel profiled sheets, and in that either a scored sheet is used or a scoring process is carried out before the sheet is folded by means of the plough folding mechanism.

33. The method according to claim 31, wherein the folding device comprises a buckle folding mechanism, wherein the shape of the first buckle of said buckle folding mechanism is adapted to the obliquely positioned edges of the sheet.

34. The method according to claim 23, wherein other transport or folding processes are carried out after the initial folding.

35. An apparatus for producing a folded sheet, comprising a feeding mechanism, an aligning device, and a folding device, wherein the folding device comprises a buckle folding mechanism, wherein the shape of the first buckle of said buckle folding mechanism is adapted to the obliquely positioned edges of the sheet.

36. The apparatus according to claim 35, wherein the buckle folding mechanism features up to twelve buckles.

37. The apparatus according to claim 35, wherein a transport section and an additional buckle folding mechanism are arranged downstream of the buckle folding mechanism, wherein the shape of the first buckle of the downstream buckle folding mechanism is adapted to the obliquely positioned edges of the sheet.

38. The apparatus according to claim 37, wherein the additional buckle folding mechanism is arranged offset relative to the folding device by 90°.

39. The apparatus according to one of claims 35, wherein the aligning device comprises a separate structural unit.

40. The apparatus according to claim 35, wherein the aligning device features stops that are adapted to the obliquely positioned edges of the sheet and rotatable about axes of rotation in the moving direction of the aligned sheet.

41. An apparatus for producing a folded sheet, comprising a feeding mechanism, an aligning device, and a folding device, wherein the aligning device features at least one stop that is rotatable about an axis of rotation in the moving direction of the aligned sheet.

42. The apparatus according to claim 41, wherein the axis of rotation extends transverse to the moving direction of the aligned sheet.

43. The apparatus according to claim 41, characterized in that the stop is fixed underneath the supporting surface of the sheet and realized in a downwardly rotatable fashion.

44. The apparatus according to claim 41, wherein the stop is fixed above the supporting surface of the sheet and realized in an upwardly rotatable fashion in the rotating direction.

45. The apparatus according to claim 41, wherein the aligning device comprises a separate structural unit that can be combined with different feeding mechanisms or folding devices.
